(19) United States
(12) Patent Application Publication
(10) Pub. No.: US 2020/0043390 A1
(43) Pub. Date: Feb. 6, 2020

(54) TABLE TOP STANCHION FOR BANNERS AND SIGNAGE

(71) Applicant: Lisa Ann Bader, Granite Bay, CA (US)

(72) Inventor: Lisa Ann Bader, Granite Bay, CA (US)

(21) Appl. No.: 16/533,100

(22) Filed: Aug. 6, 2019

Related U.S. Application Data
(60) Provisional application No. 62/715,125, filed on Aug. 6, 2018.

(51) Int. Cl. G09F 17/00; G09F 7/20

(52) U.S. Cl. CPC G09F 17/00; G09F 2007/1834; G09F 7/20

(57) ABSTRACT

An apparatus and method for table top display of a banner or pennant for a festive occasion. The apparatus includes a vertically adjustable stanchion dimensioned for table top display of a celebratory banner. The stanchion includes a base of a weighted material and an upright telescopically adjustable pole. A bottom end of the telescopically adjustable pole is secured to the base. The banner is attachable to a top segment of the telescopically pole. The base of the stanchion is weighted to maintain the stanchion in an upright condition when suspending an end of the banner carried by the stanchion.

### CROSS-REFERENCE TO RELATED APPLICATION

This application claims the benefit of priority of U.S. provisional application No. 62/715,125, filed Aug. 6, 2018, the contents of which are herein incorporated by reference.

### BACKGROUND OF THE INVENTION

The present invention relates to party banners and signage and, more particularly, to methods and apparatus for suspending party banners and signage.

Currently there are a number of solutions for banner or sign stands. Some of these solutions attempt to display commercial-grade banners or signs, but these solutions fail to meet the needs of the home entertainment and celebrations industry which typically use non-commercial banners or signs, such as Happy Birthday banners (where each letter is printed on a panel or flag of identical size and then the panels or flags are strung together with a string or other material).

Other solutions are unable to meet the needs of the industry because their large-scale size, and commercial grade materials, are much too big for use on a tabletop. Still other solutions seek to display signs or banners in retail store environments where there may be affixed to a store shelf or retail merchandising display. Some solutions address digital signage, but not physical signage.

As can be seen, there is a need for an improved apparatus and methods to conveniently display a banner atop a horizontal surface as part of a celebration or for informational purposes.

### SUMMARY OF THE INVENTION

In one aspect of the present invention, an apparatus for suspending a banner above a horizontal support surface is disclosed. The apparatus includes a base dimensioned to be supported on a table top. A telescoping pole is removably attached to the base. An attachment ring is disposed at a top end of the telescoping pole.

In some embodiments, the base includes a frusto-conical body having an interior cavity adapted to receive a quantity of a weighted material. Preferably, the frusto-conical body filled is with the quantity of the weighted material.

In some embodiments, an aperture is defined in a top end of the base and is dimensioned to removably attach a bottom end of the telescoping pole to the base. The aperture may be a threaded aperture dimensioned to threadingly receive a cooperating thread extending from the bottom end of the telescoping pole. Alternatively, the aperture is formed as a socket to receive the bottom end of the telescoping pole and retain the telescoping pole in an upright condition with the banner suspended.

In some embodiments, the telescoping pole includes a plurality of segments adjustably interconnected to extend or retract the telescoping pole. A plurality of adjustment apertures are disposed in a spaced apart relation in one of a bottom segment and the top segment. A set pin is received in one of the plurality of apertures to retain the telescoping pole in a selected length. A spring may also be provided to bias the set pin within the aperture.

In other aspect of the invention an apparatus for suspending a banner above a horizontal support surface includes a base dimensioned to be supported on a table top. The base has a frusto-conical body and a mounting aperture in a top end of the base. A telescoping pole has a plurality of segments that are adjustably interconnected to extend or retract the telescoping pole. A bottom end of the telescoping pole is removably receivable in the mounting aperture. An attachment ring disposed at a top end of the telescoping pole.

In some embodiments, an interior cavity of the base is adapted to receive a quantity of a weighted material. The mounting aperture may be a socket dimensioned to receive the bottom end of the telescoping pole and retain the telescoping pole in an upright condition with the banner suspended.

In other embodiments, the mounting aperture may be a threaded aperture dimensioned to threadingly receive a cooperating thread extending from the bottom end of the telescoping pole.

These and other features, aspects and advantages of the present invention will become better understood with reference to the following drawings, description and claims.

### BRIEF DESCRIPTION OF THE DRAWINGS

FIG. 1 is a perspective view of the invention, shown in use;

FIG. 2 is a perspective view of a single stand assembly 10;

FIG. 3 is an exploded view of a single stand assembly 10;

FIG. 4 is a section view of the invention, taken along line 4-4 in FIG. 2; and

FIG. 5 is a perspective view of an alternate embodiment of a single stand assembly 10.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides an improved apparatus and method to suspend a party banner in the absence of a flat, vertical surface. It would be desirable to have an easy way to display banners or signs for celebrations and other events where there is no convenient wall or other vertical plane to attach the banner or sign to.

Furthermore, it would be desirable to display banners or signs without the need of a ladder or the potential safety issues that may arise from climbing on a ladder. Still further, it would be desirable to display a banner without incurring the damage that may result from using tape, nails or thumbtacks to affix the banners or signs to a wall or other vertical plane. Even further, it would be desirable to be able to display signs and banners in a prominent position near the location of other key event items. Therefore, there currently exists a need in the industry for a discrete banner/sign stand that may be used on a tabletop or another horizontal surface.

Aspects of the present invention allows someone in a home or office environment to easily display a banner on a tabletop or other horizontal surface, such as a shelf or atop a filing cabinet.

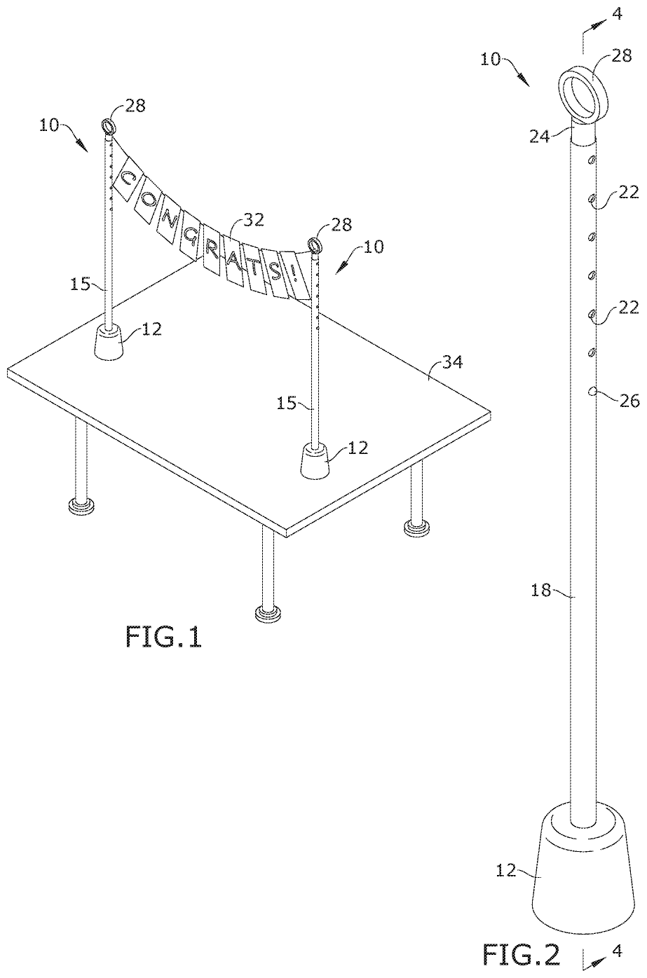

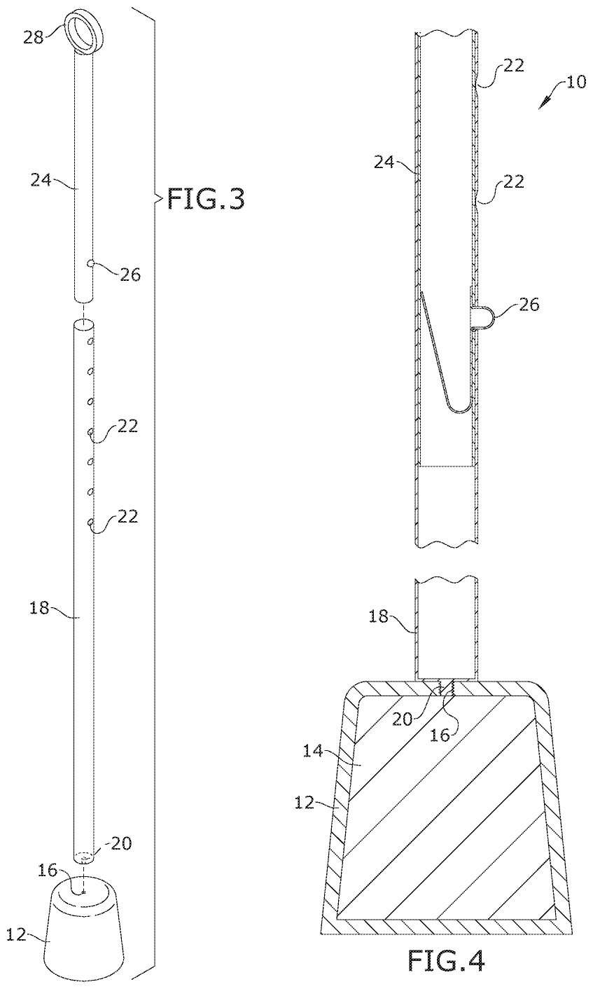

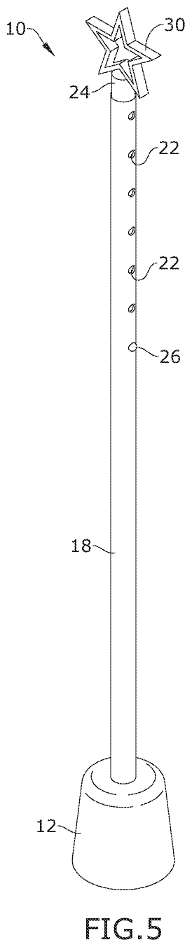

As seen in reference to the drawings of FIGS. 1-5, an apparatus for suspending a banner on a horizontal support surface, such as a table top, is shown. The apparatus includes a stanchion 10 having a base 12 and a telescoping pole extending from the base 12. Typically, a plurality of stanchions 10 are disposed in a spaced apart relation on a horizontal surface, such as a table top 34.

The base 12 may be formed as a frusto-conical body with a quantity of a weighted material 14 carried within an interior cavity of the body. The quantity of the weighed material 14 is selected to maintain the stanchion 10 in an upright orientation when a banner 32 is suspended from a top end of the telescoping pole 15.

A mounting aperture 16 is provided in a top end of the base 12 and is dimensioned to attach a bottom end of the telescoping pole 15 to the base 12. The mounting aperture 16 may be a threaded aperture to receive a thread 20 extending from the bottom end of the telescoping pole 15. As will be appreciated from the present disclosure, the mounting aperture 16 may also be formed as a socket to receive the bottom end of the telescoping pole 15 and retain it in an upright condition with the banner 32 suspended.

The telescoping pole 15 has a plurality of segments adjustably interconnected to extend or retract the telescoping pole 15. In the non-limiting embodiment shown, the telescoping pole 15 may have a bottom segment 18 a top segment 24. One of the bottom segment 18 and the top segment 24 may have a plurality of adjustment apertures 22 disposed in a spaced apart relation. The plurality of adjustment apertures 22 are configured to receive a set pin 26 for maintaining the plurality of segments in a desired vertical elevation. The set pin 26 is resiliently biased for engagement with the aperture, such as by a spring.

An attachment ring 28 is disposed at a top end of the top segment 24. The attachment ring 28 provides for an attachment point for securing a top suspension element of the banner 32 to the stanchion 10. For banners 32 with a second, or lower suspension element, the second suspension element may be attached to one of the plurality of adjustment apertures that are not used to receive the set pin 26. As will be appreciated from the present disclosure, the attachment ring 28 may be a circular ring or may include a decorative design element selected for the occasion.

In use the stanchion 10 is supported on a horizontal support surface 34, typically a tabletop. However, as will be appreciated from the present disclosure, the horizontal support surface 34 does not need to be at the same height to support each stanchion 10, since the height of the stanchion 10 is adjustable.

The base 12 may be placed on the support surface 34 and the telescopic pole 15 inserted or otherwise attached to the base 12. A top suspension element of the banner, such as a wire, string, hook, and the like is attached to the attachment ring 28. The height of the telescopic pole 15 may then be adjusted to obtain a desired vertical elevation of the suspended banner 32 so that a step ladder, or the like isn't required to mount the banner 31.

When the event is concluded, the stanchions 10 may be lowered, permitting the banner 32 to be conveniently removed. The telescopic pole 15 may then be fully retracted and separated from the base 12 for easy shipment or storage until needed for a subsequent event.

It should be understood, of course, that the foregoing relates to exemplary embodiments of the invention and that modifications may be made without departing from the spirit and scope of the invention as set forth in the following claims.

What is claimed is:

1. An apparatus for suspending a banner above a horizontal support surface, comprising:
a base dimensioned to be supported on a table top;
a telescoping pole removably attached to the base; and
an attachment ring disposed at a top of the telescoping pole.

2. The apparatus of claim 1, the base further comprising:
a frusto-conical body having an interior cavity adapted to receive a quantity of a weighted material.

3. The apparatus of claim 2, further comprising:
the frusto-conical body filled with the quantity of the weighted material.

4. The apparatus of claim 1, further comprising:
an aperture defined in a top end of the base that is dimensioned to removably attach a bottom end of the telescoping pole to the base.

5. The apparatus of claim 4, wherein the aperture is a threaded aperture dimensioned to threadingly receive a cooperating thread extending from the bottom end of the telescoping pole.

6. The apparatus of claim 4, wherein the aperture is formed as a socket to receive the bottom end of the telescoping pole and retain the telescoping pole in an upright condition with the banner suspended.

7. The apparatus of claim 4, the telescoping pole further comprising:
a plurality of segments adjustably interconnected to extend or retract the telescoping pole.

8. The apparatus of claim 7, further comprising:
a plurality of adjustment apertures disposed in a spaced apart relation in one of a bottom segment and a top segment; and
a set pin received in one of the plurality of adjustment apertures to retain the telescoping pole in an extended or a retracted position.

9. The apparatus of claim 8, further comprising:
a spring to bias the set pin within the aperture.

10. An apparatus for suspending a banner above a horizontal support surface, comprising:
a base dimensioned to be supported on a table top, the base having a frusto-conical body and a mounting aperture in a top end of the base;
a telescoping pole having a plurality of segments adjustably interconnected to extend or retract the telescoping pole, a bottom end of the telescoping pole being removably receivable in the mounting aperture; and
an attachment ring disposed at a top of the telescoping pole.

11. The apparatus of claim 10, further comprising:
an interior cavity of the base that is adapted to receive a quantity of a weighted material.

12. The apparatus of claim 11, wherein the mounting aperture is a socket dimensioned to receive the bottom end of the telescoping pole and retain the telescoping pole in an upright condition with the banner suspended.

13. The apparatus of claim 11, wherein the mounting aperture a threaded aperture dimensioned to threadingly receive a cooperating thread extending from the bottom end of the telescoping pole.

14. A method of suspending a banner on a table top display, comprising:
providing a plurality of stanchions having a base dimensioned to be supported on the table top, the base having a frusto-conical body and a mounting aperture in a top end of the base;
attaching a telescoping pole having a plurality of segments adjustably interconnected to extend or retract the telescoping pole, in the mounting aperture of each of the plurality of stanchions; and
attaching a first end of the banner to an attachment ring disposed at a top of the telescoping pole of a first stanchion.

15. The method of claim 14, further comprising:
attaching a second end of the banner to the attachment ring of a second stanchion.

16. The method of claim 15, further comprising:
extending the telescoping pole of one or more of the first stanchion and the second stanchion to elevate the banner to a desired elevation.
